(19) United States
(12) Patent Application Publication
(10) Pub. No.: US 2019/0207206 A1
(43) Pub. Date: Jul. 4, 2019

(54) COMPOSITIONS AND USES THEREOF

(71) Applicant: Imerys Graphite & Carbon Switzeriand Ltd., Bodio (CH)

(72) Inventors: Pirmin ULMANN, Giubiasco (CH); Sergio PACHECO BENITO, Biasca (CH); Simone ZÜRCHER, Origlio (CH); Patrick LANZ, Bellinzona (CH); Michael SPAHR, Bellinzona (CH)

(21) Appl. No.: 16/332,082

(22) PCT Filed: Sep. 12, 2017
(86) PCT No.: PCT/EP2017/072934

§ 371 Date: Mar. 11, 2019

(30) Foreign Application Priority Data
Sep. 12, 2016 (EP) 16188374.9

(51) Int. Cl. H01M 4/134; H01M 4/1395; H01M 4/38; H01M 4/587; H01M 4/62; H01M 10/0525

(52) U.S. Cl. CPC H01M 4/134; H01M 4/1395; H01M 4/386; H01M 2004/027; H01M 4/622; H01M 4/625; H01M 10/0525; H01M 4/587

(57) ABSTRACT

A silicon particulate suitable for use as active material in a negative electrode of a Li-ion battery, to a precursor composition comprising the silicon particulate, a negative electrode comprising the silicon particulate and/or precursor composition, a Li-ion battery comprising the negative electrodes, the use of the silicon particulate to inhibit or prevent silicon pulverization when used as active material in a negative electrode of a Li-ion battery and/or (ii) to maintain electrochemical capacity of a negative electrode, methods for making the silicon particulate, precursor composition, negative electrode and Li-ion battery, and devices comprising the silicon particulate and/or precursor composition and/or negative electrode and/or Li-ion battery.

### TECHNICAL FIELD

The present invention is directed to a silicon particulate suitable for use as active material in a negative electrode of a Li-ion battery, to a precursor composition comprising the silicon particulate, to a negative electrode comprising the silicon particulate and/or precursor composition, to a Li-ion battery comprising the negative electrodes, to the use of the silicon particulate to inhibit or prevent silicon pulverization when used as active material in a negative electrode of a Li-ion battery and/or (ii) to maintain electrochemical capacity of a negative electrode, to methods for making the silicon particulate, precursor composition, negative electrode and Li-ion battery, and to devices comprising the silicon particulate and/or precursor composition and/or negative electrode and/or Li-ion battery.

### BACKGROUND

Metals forming compounds or alloys with lithium exhibit very high specific charge in the negative electrode in lithium ion batteries. For example, the theoretical specific charge of silicon metal electrodes can be up to 4′200 mAh/g. However, silicon particles can crack owing to the large volume expansion of silicon when inserting lithium electrochemically (i.e., during lithium intercalation and de-intercalation). This cracking problem is known as silicon pulverization. Further, the creation of new surfaces during particle cracking can lead to excessive electrolyte decomposition and de-contacting of the silicon from the electrode. Silicon pulverization manifests as specific charge losses after several charge/discharge cycles as well as irreversible capacity during first cycle charge and discharge and, in general, poor cycle stability. These are significant limitations that have delayed the adoption of silicon-based active materials in commercial lithium-ion batteries.

There is ongoing need to develop new silicon active materials for electrode materials which address the problem of silicon pulverization and the concomitant cycling stability problems.

### SUMMARY OF THE INVENTION

A first aspect of the present invention is directed to a silicon particulate suitable for use as active material in a negative electrode of a Li-ion battery, having one or more of:
(i) a microporosity of at least 10%,
(ii) a BJH average pore width of from about 110 to 200 Å, and
(iii) a BJH volume of pores of at least about 0.32 cm³/g.

A second aspect of the present invention is directed to a silicon particulate having a nanostructure which (i) inhibits or prevents silicon pulverization when used as active material in a negative electrode of a Li-ion battery and/or (ii) maintains electrochemical capacity of a negative electrode.

A third aspect of the present invention is directed to a precursor composition for a negative electrode of a Li-ion battery, the precursor composition comprising a silicon particulate according to the first and/or second aspects.

A fourth aspect of the present invention is directed to an electrode comprising a silicon particulate according to the first and/or second aspects.

A fifth aspect of the present invention is directed to an electrode comprising a precursor composition according to the third aspect.

A sixth aspect of the present invention is directed to a Li-ion battery comprising an electrode according to the fourth and/or fifth aspect, optionally wherein (i) silicon pulverization does not occur during 1st cycle lithium interaction and de-intercalation and/or (ii) electrochemical capacity is maintained after 100 cycles.

A seventh aspect of the present invention is directed to a Li-ion battery comprising a negative electrode which comprises a silicon particulate as active material, wherein (i) silicon pulverization does not occur during 1st cycle lithium intercalation and de-intercalation and/or (ii) electrochemical capacity is maintained after 100 cycles.

An eighth aspect of the present invention is directed to the use of a a silicon particulate as active material in a negative electrode of a Li-ion battery to inhibit or prevent silicon pulverization during cycling, for example, during 1st cycle Li intercalation and de-intercalation, and/or to maintain electrochemical capacity after 100 cycles.

A ninth aspect of the present invention is directed to the use, as active material in a negative electrode of a Li-ion battery, of a silicon particulate according to the first aspect, for improving the cycling stability of the Li-ion battery compared to a Li-ion battery which comprises a silicon particulate which is not milled and/or does not have a nanostructure which inhibits or prevents silicon pulverization during cycling, for example, during 1st cycle Li intercalation, and/or does not have a nanostructure which maintains electrochemical capacity after 100 cycles.

A tenth aspect of the present invention is directed to the use of a a carbonaceous particulate material in a negative electrode of a Li-ion battery, wherein the electrode comprises a silicon particulate according to the first aspect.

An eleventh aspect of the present invention is directed to a method of making a silicon particulate, comprising wet-milling a silicon starting material under conditions to produce a milled silicon particulate have a nanostructure which inhibits or prevents silicon pulverization when used as active material in a negative electrode of a Li-ion battery and/or which maintains electrochemical capacity of a negative electrode.

A twelfth aspect of the present invention is directed to a a method of preparing a precursor composition for a negative electrode of a Li-ion battery, comprising preparing, obtaining, providing or supplying a silicon particulate according to the first aspect or obtainable by a method according to the eleventh aspect, and combining with a carbonaceous particulate.

A thirteenth aspect of the present invention is directed to a method of preparing a precursor composition for a negative electrode of a Li-ion battery, comprising, preparing, obtaining, providing or supplying a carbonaceous particulate and combining with a silicon particulate according to the first aspect.

A fourteenth aspect of the present invention is directed to a method of preparing a precursor composition for a negative electrode of a Li-ion battery, comprising combining a silicon particulate according to any the first aspect or obtainable by a method according to the eleventh aspect with a carbonaceous particulate.

A fifteenth aspect of the present invention is directed to a method of manufacturing a negative electrode for a Li-ion battery, comprising forming the negative electrode from a precursor composition according to the second aspect or obtainable by a method according to any the twelfth, thirteenth or fourteenth aspect, optionally wherein the precursor composition comprises additional components or is combined with additional components during forming, optionally wherein the additional components include binder.

A sixteenth aspect of the present invention is directed to a a device comprising the electrode according to the fourth or fifth aspect, or comprising a Li-ion battery according to sixth or seventh aspect.

A seventeenth aspect of the present invention is directed to an energy storage cell comprising a silicon particulate according to the first aspect or a precursor composition according to the second aspect.

An eighteenth aspect of the present invention is directed to an energy storage and convention system comprising a silicon particulate according to the first aspect or a precursor composition according to the second aspect.

### BRIEF DESCRIPTION OF THE DRAWINGS

FIG. 1 is an SEM picture of silicon particulate Nano Si-1 prepared according to the Examples.

FIG. 2 is a graph plotting the derivatives dV/dlog(w) (V=pore volume and w=pore width) against the pore size distribution of silicon particulates Nano-Si 1 and Nano-Si 2 prepared according to the Examples.

FIG. 3 is a graph showing the cycling performance of a negative electrode made from Dispersion formulation 1 containing silicon particulate Nano-Si 3 (filled circles) and a negative electrode made from Dispersion formulation 2 containing a commercially available Nano-Si material (open circles).

FIG. 4 shows the 1^{st} cycle lithium intercalation (black curves) and de-intercalation (gray curves) of a negative electrode made from Dispersion formulation 1 containing silicon particulate Nano-Si 3 (FIG. 4A) and a negative electrode made from Dispersion formulation 2 containing a commercially available Nano-Si material (FIG. 4B).

### DETAILED DESCRIPTION OF THE INVENTION

It has surprisingly been found that by controlling the nanostructure and morphology of a silicon particulate, by wet-milling a particulate silicon starting material under conditions which promote the formation of said nanostructure and morphology, the problem of silicon pulverization during electrochemical lithium insertion/extraction can be inhibited or mitigated, thus improving cycling stability and/or reducing capacity losses, when using said silicon particulate as active material in a negative electrode of a Li-ion battery.

The silicon particulate suitable for use as active material in a negative electrode of a Li-ion battery has one or more of:
(i) a microporosity of at least about 10%,
(ii) a BJH average pore width of from about 110 Å to about 200 Å, and
(iii) a BJH volume of pores of at least about 0.32 cm³/g

By “microporosity” is meant the % of external surface are of micropores in relation to the total BET specific surface are of the particulate. As used herein, a “micropore” means a pore width of less than 20 Å, a “mesopore” means a pore width of from 20 Å to 500 Å, and a “macropore” means a pore width of greater than 500 Å, in accordance with the IUPAC classification.

In certain embodiments, the silicon particulate has one or more of:
(i) a microporosity of from about 15% to about 50%,
(ii) a BJH average pore width of from about 130 Å to about 180 Å, and
(iii) a BJH volume of pores of at least about 0.35 cm³/g

In certain embodiments, the silicon particulate has one or more of:
(i) a microporosity of from about 15% to about 25%, for example, from about 18-22%
(ii) a BJH average pore width of from about 150 Å to about 180 Å, for example, from about 160 Å to about 170 Å, and
(iii) a BJH volume of pores of at least about 0.45 cm³/g, for example, from about 0.50 cm³/g to about 0.60 cm³/g.

In certain embodiments, the silicon particulate has one or more of:
(i) a microporosity of from about 25% to about 35%, for example, from about 28-32%
(ii) a BJH average pore width of from about 130 Å to about 160 Å, for example, from about 140 Å to about 150 Å, and
(iii) a BJH volume of pores of at least about 0.35 cm³/g, for example, from about 0.35 cm³/g to about 0.45 cm³/g.

In certain embodiments, the silicon particulate has at least two of (i), (ii) and (iii), for example, (i) and (ii), or (ii) and (iii), or (i) and (iii). In certain embodiments, the silicon particulate has each of (i), (ii) and (iii).

In certain embodiments, the silicon particulates may be further characterized in having:
(a) a percentage of the total pore volume which resides in pores having a pore width of from 400 to 800 Å which is greater than the percentage of the total pore volume which resides in pores having a pore width of greater than 800 Å to 1200 Å; and/or
(b) a maximum pore volume contribution at a pore width of between about 300 and about 500 Å, or between about 300 and about 400 Å, or between about 400 and about 500 Å.

The maximum pore volume corresponds to the peak value when plotting the derivatives dV/dlog(w) (V=pore volume and w=pore width) against the pore size distribution, as shown in FIG. 2. In other words, the “maximum pore volume” indicates at which pore width the pore volume contribution is highest.

Additionally or alternatively, in certain embodiments, in addition to (i), (ii) and/or (iii) above, the silicon particulate may have:
(1) a BET specific surface area (SSA) of at least about 70 m²/g; and/or
(2) an average particle size of less than about 750 Å.

In certain embodiments, the silicon particulate has a BET SSA of from about 100 m²/g to about 300 m²/g, for example, from about 100 m²/g to about 200 m²/g, or from about 120 m²/g to about 180 m²/g, or from about 140 m²/g to about 180 m²/g, or from about 150 m²/g to about 170 m²/g, or from about 155 m²/g to about 165 m²/g.

In certain embodiments, the silicon particulate has an average particle size of from about 100 Å to about 600 Å, for example, from about 100 Å to about 500 Å, or from about 100 Å to about 400 Å, or from about 100 Å to about 300 Å, or from about 100 Å to about 250 Å, or from about 100 Å to about 200 Å, or from about 110 Å to about 190 Å, or from about 120 Å to about 180 Å, or from about 130 Å to about 180 Å, or from about 140 Å to about 180 Å, or from about 150 Å to about 170 Å, or from about 155 Å to about 165 Å.

In certain embodiments, the silicon particulate has an average particle size of from about 100 Å to about 200 Å. In certain embodiments, the silicon particulate has an average particle size of from about 140 Å to about 180 Å. In certain embodiments, the silicon particulate has an average particle size of from about 150 Å to about 170 Å.

In certain embodiments, the silicon particulate has a nanostructure which inhibits or prevents silicon pulverization when used as active material in a negative electrode of a Li-ion battery.

By “inhibiting or preventing silicon pulverization” is meant that Li is de-intercalated in a single amorphous phase in a continuous process, more particularly, that the nanostructure promotes the formation of amorphous LiₓSi with the gradual change of X in one continuous phase, and in the substantial absence of the formation of two phases containing crystalline Si and crystalline Li₁₅S₄. The formation of crystalline Li₁₅S₄ is detectable in a 1^{st} cycle Li intercalation and de-intercalation curve by the presence of a characteristic plateau in the de-intercalation curve part way between full charge and full discharge. The plateau is characterized in that the Potential vs. Li/Li+ [V] (which is the Y-axis of the 1^{st} cycle Li intercalation and de-intercalation curve) changes by no more than about 0.05 V across a Specific Charge/372 mAh/g (which is the X-axis of the 1^{st} cycle Li interaction and de-intercalation curve) of 0.2. An example of this characteristic plateau is shown in FIG. 2. Without wishing to be bound by theory, it is believed that the silicon particulate reduces the extent of volume expansion during lithium intercalation, by preventing or at least inhibiting the formation of Si-Li crystalline alloy phases, and promotes the formation of an amorphous LiₓSi phase. The result is improvement in cycle stability and reduction in specific charge loss.

Additionally or alternatively, therefore, in certain embodiments, the silicon particulate has a nanostructure which maintains electrochemical capacity of a negative electrode, of a Li-ion battery when used as active material. By “maintains electrochemical capacity”, means that the specific charge of the negative electrode after 100 cycles is at least 85% of the specific charge after 10 cycles, for example, at least 90% of the specific charge after 10 cycles. In other words, the negative electrode comprising the silicon particulate may have at least 85% capacity retention after 100 cycles, for example, at least 90% capacity retention after 100 cycles.

In certain embodiments, the silicon particulate is wet-milled, for example, wet-milled in accordance with the methods described herein.

Method of making Silicon Particulate

The silicon particulate may be manufactured by wet-milling a silicon particulate starting material under conditions to produce a silicon particulate according to the first aspect and/or having a nanostructure which inhibits or prevents silicon pulverization and/or maintains electrochemical capacity when use as active material in a negative electrode of a Li-ion battery. By “wet-milling” is meant milling in the presence of liquid, which may be organic, aqueous, or a combination thereof.

In certain embodiments, the silicon particulate starting material comprises silicon microparticles having particle sizes of from about 1 μm to about 100 μm, for example, from about 1 μm to about 75 μm, or from about 1 μm to about 50 μm, or from about 1 μm to about 25 μm, or from about 1 μm to about 10 μm. In certain embodiments, the silicon particulate starting material is a micronized silicon particulate having a particle size of from about 1 μm to about 10 μm.

In certain embodiments, the method comprises one or more of the following:
(i) wet-milling in the presence of solvent, for example, an aqueous alcohol-containing mixture,
(ii) wet-milling in a rotor-stator mill, a colloidal mill or a media mill,
(iii) wet-milling under conditions of high shear and/or high power density,
(iv) wet-milling in the presence of relatively hard and dense milling media, and
(v) drying

In certain embodiments, the method comprise two or more of (i), (ii), (iii) and (iv) followed by drying, for example, three or more of (i), (ii), (iii) and (iv) followed by drying, or all of (i), (ii), (iii) and (iv) followed by drying.

(i) wet milling in the presence of an aqueous alcohol-containing mixture

The solvent may be organic or aqueous, or may be a combination of an organic solvent with water. In certain embodiments, the solvent is organic, for example, consists of an organic solvent or a mixture of different organic solvents. In certain embodiments, the solvent is aqueous, for example, consists of water. In certain embodiments, the solvent is a mixture of organic solvent and water, for example, in a weight ratio of from about 99:1 to about 1:99. In such embodiments, the organic solvent may comprise a mixture of different organic solvents. Inn such embodiments, the solvent may be predominantly organic, for example, at least about 90% organic, or at least 95% organic, or at least 99% organic, or at least 99.5% organic, or at least 99.9%. In certain embodiments, solvent is predominantly organic and comprises water in trace amounts, for example, from about 0.01 wt. % to about 1.0 wt. %, for example, from about 0.01 wt. % to about 0.5 wt. %, or from about 0.01 wt. % to about 0.1 wt. %, or from about 0.01 wt. % to about 0.05 wt. %, based on the total weight of the solvent.

In certain embodiments, the solvent is an aqueous alcohol-containing mixture may comprise water and alcohol in a weight ratio of from about 10:1 to about 1:1, for example, from about 8:1 to about 2:1, or from about 6:1 to about 3:1, or from about 5:1 to about 4:1. The total amount of liquid may be such to produce a slurry of the silicon particulate starting material having a solids content of no greater than about 20 wt. %, for example, no greater than about 15 wt. %, or at least about 5 wt. %, or at least about 10 wt. %. In these embodiments, the alcohol could be replaced with an organic solvent other than an alcohol, or a mixture of organic solvents comprising alcohol and another organic solvents), or a mixture of organic solvents other than alcohol, with the weight ratios given above pertaining to the total amount of organic solvent.

The alcohol may be a low molecular weight alcohol having up to about 4 carbon atoms, for example, methanol, ethanol, propanol or butanol. In certain embodiments, the alcohol is propanol, for example, isopropanol.

(ii) and (iii)

In certain embodiments, the wet-milling is conducted in a rotor stator mill, a colloidal mill or a media mill. These mills are similar in that they can be used to generate high shear conditions and/or high power densities.

A rotor-stator mill comprises a rotating shaft (rotor) and an axially fixed concentric stator. Toothed varieties have one or more rows of intermeshing teeth on both the rotor and the stator with a small gap between the rotor and stator, which may be varied. The differential speed between the rotor and the stator imparts extremely high shear. Particle size is reduced by both the high shear in the annular region and by particle-particle collisions and/or particle-media collisions, if media is present.

A colloidal mill is another form of rotor-stator mill. It is composed of a conical rotor rotating in a conical stator. The surface of the rotor and stator can be smooth, rough or slotted. The spacing between the rotor and stator is adjustable by varying the axial location of the rotor to the stator. Varying the gap varies not only the shear imparted to the particles but also the mill residence time and the power density applied. Particle size reduction may be affected by adjusting the gap and the rotation rate, optionally in the presence of media.

Media mills are different in operation than a rotor-stator mill but likewise can be used to generate high shear conditions and power densities. The media mill may be a pearl mill or bead mill or sand mill. The mill is comprises a milling chamber and milling shaft. The milling shaft typically extends the length of the chamber. The shaft may have either radial protrusions or pins extending into the milling chamber, a series of disks located along the length of the chamber, or a relatively thin annular gap between the shaft mill chamber. The typically spherical chamber is filled with the milling media. Media is retained in the mill by a mesh screen located at the exit of the mill. The rotation of the shaft causes the protrusions to move milling media, creating conditions of high shear and power density. The high energy and shear that result from the movement of the milling media is imparted to the particles as the material is circulated through the milling chamber.

The rotation speed within the mill may be at least about 5 m/s, for example, at least about 7 m/s or at least about 10 m/s. The maximum rotation speed may vary from mill to mill, but typically is no greater than about 20 m/s, for example, no greater than about 15 m/s. Alternatively, the speed may be characterized in terms of rpm. In certain embodiments, the rpm of the rotor-stator or milling shaft in the case of a media mill may be at least about 5000 rpm, for example, at least about 7500 rpm, or at least about 10,000 rpm, or at least about 11,000 rpm. Again, maximum rpm may be vary from mill to mill, but typically is no greater than about 15,000 rpm.

In certain embodiments, the rpm of the rotor-stator or milling shaft in the case of a media mill may be at least about 500 rpm, for example, at least about 750 rpm, or at least about 1000 rpm, or at least about 1500 rpm. Again, maximum rpm may be vary from mill to mill, but typically is no greater than about 3000 rpm.

Power density may be at least about 2 kW/l (l=litre of slurry), for example, at least about 2.5 kW/l, or at least about 3 kW/l. In certain embodiments, the power density is no greater than about 5 kW/l, for example, no greater than about 4 kW/l.

Residence in time within the mill is less than 24 hours, for example, equal to or less than about 18 hours, or equal to or less than about 12 hours, or equal to or less than about 6 hours, or equal to or less than about 4 hours, or equal to or less than about 220 minutes, or equal to or less than about 200 minutes, or equal to or less than about 180 minutes, or equal to or less than about 160 minutes, or equal to or less than about 140 minutes, or equal to or less than about 120 minutes, or equal to or less than about 100 minutes, or equal to or less than about 80 minutes, or equal to or less than about 60 minutes, or equal to or less than about 40 minutes, or equal to or less than about 20 minutes.

(iv) wet-milling in the presence of relatively hard and dense milling media

In certain embodiments, the milling media is characterized by having a density of at least about 3 g/cm³, for example, at least about 3.5 g/cm³, or at least about 4.0 g/cm³, or at least about 4.5 g/cm³, or at least about 5.0 g/cm³, or at least about 5.5 g/cm³, or at least about 6.0 g/cm³. In certain embodiments, the milling media is a ceramic milling media, for example, yttria-stabilized zirconia, ceria-stabilized zirconia, fused zirconia, alumina, alumina-silica, alumina-zirconia, alumina-silica-zironia, and ytrria or ceria stabilized forms thereof. The milling media, for example, ceramic milling media, may be in the form of beads. The milling media, for example, ceramic milling media may have a size of less than about 10 mm, for example, equal to or less than about 8 mm, or equal to or less than about 6 mm, or equal to or less than about 4 mm, or equal to or less than about 2 mm, or equal to or less than about 1 mm, or equal to or less than about 0.8 mm, or equal or less than about 0.6 mm, or equal to or less than about 0.5 mm. In certain embodiments, the milling media has a size of at least 0.05 mm, for example, at least about 0.1 mm, or at least about 0.2 mm, or at least about 0.3 mm, or at least about 0.4 mm.

In certain embodiments, wet milling is conducted in a planetary ball mill with milling media, for example, ceramic milling media, having a size of up to about 10 mm.

(v) drying

Drying may be effected by any suitable technique using any suitable drying equipment. Typically, the first step of the drying (or, alternatively, the last action of the milling step) is recovering the solid material from the dispersion, for example by filtration or centrifugation, which removes the bulk of the liquid before the actual drying takes place. In some embodiments, the drying step c) is carried out by a drying technique selected from subjecting to hot air/gas in an oven or furnace, spray drying, flash or fluid bed drying, fluidized bed drying and vacuum drying.

For example, the dispersion may be directly, or optionally after filtering the dispersion through a suitable filter (e.g. a <100 μm metallic or quartz filter), introduced into an air oven at typically 120 to 230° C., and maintained under these conditions, or the drying may be carried out at 350° C., e.g., for 3 hours. In cases where a surfactant is present, the material may optionally be dried at higher temperatures to remove/destroy the surfactant, for example at 575° C. in a muffle furnace for 3 hours.

Alternatively, drying may also be accomplished by vacuum drying, where the processed dispersion is directly, or optionally after filtering the dispersion through a suitable filter (e.g. a <100 μm metallic or quartz filter), introduced, continuously or batch-wise, into a closed vacuum drying oven. In the vacuum drying oven, the solvent is evaporated by creating a high vacuum at temperatures of typically below 100° C., optionally using different agitators to move the particulate material. The dried powder is collected directly from the drying chamber after breaking the vacuum.

Drying may for example also be achieved with a spray dryer, where the processed dispersion is introduced, continuously or batch wise, into a spray dryer that rapidly pulverizes the dispersion using a small nozzle into small droplets using a hot gas stream. The dried powder is typically collected in a cyclone or a filter. Exemplary inlet gas temperatures range from 150 to 350° C., while the outlet temperature is typically in the range of 60 to 120° C.

Drying can also be accomplished by flash or fluid bed drying, where the processed expanded graphite dispersion is introduced, continuously or batch wise, into a flash dryer that rapidly disperses the wet material, using different rotors, into small particles which are subsequently dried by using a hot gas stream. The dried powder is typically collected in a cyclone or a filter. Exemplary inlet gas temperatures range from 150 to 300° C. while the outlet temperature is typically in the range of 100 to 150° C.

Alternatively, the processed dispersion may be introduced, continuously or batch-wise, into a fluidized bed reactor/dryer that rapidly atomizes the dispersion by combining the injection of hot air and the movement of small media beads. The dried powder is typically collected in a cyclone or a filter. Exemplary inlet gas temperatures range from 150 to 300° C. while the outlet temperature is typically in the range of 100 to 150° C.

Drying can also be accomplished by freeze drying, where the processed dispersion is introduced, continuously or batch wise, into a closed freeze dryer where the combination of freezing the solvent (typically water or water/alcohol mixtures) and applying a high vacuum sublimates the frozen solvent. The dried material is collected after all solvent has been removed and after the vacuum has been released.

The drying step may optionally be carried out multiple times. If carried out multiple times, different combinations of drying techniques may be employed. Multiple drying steps may for example be carried out by subjecting the material to hot air (or a flow of an inert gas such as nitrogen or argon) in an oven/furnace, by spray drying, flash or fluid bed drying, fluidized bed drying, vacuum drying or any combination thereof.

In some embodiments, the drying step is conducted at least twice, preferably wherein the drying step comprises at least two different drying techniques selected from the group consisting of subjecting to hot air in an oven/furnace, spray drying, flash or fluid bed drying, fluidized bed drying and vacuum drying.

In certain embodiments, drying is accomplished in an oven, for example, in air at a temperature of at least about 100° C., for example, at least about 105° C., or at least about 110° C. In other embodiments, drying is done by spray drying, for example, at a temperature of at least about 50° C., or at least about 60° C., or at least about 70° C.

### Precursor Compositions

The silicon particulate may be used as active material in a negative electrode for a Li-ion battery. In certain embodiments, the silicon particulate is combined with a suitable carbon matrix and provided as a precursor composition or a negative electrode. The addition of a carbon matrix may further improve cycling stability by further reducing volume expansion during lithium intercalation and de-intercalation. The carbon matrix may comprise one or more carbonaceous particulate materials. In certain embodiments, the carbon matrix has a BET SSA of less than about 100 m²/g, for example, less than about 80 m²/g, or less than about 60 m²/g, or less than about 50 m²/g, or less than about 40 m²/g, or less than about 30 m²/g, or less than about 20 m²/g or less than about 10 m²/g or less than about 8.0 m²/g, or less than about 6.0 m²/g, or less than about 4.0 m²/g. The one or more carbonaceous particulates may be selected to obtain a carbon matrix having the desired BET SSA.

In certain embodiments, the precursor composition comprises the silicon particulate and a carbonaceous particulate material, for example, at least two different types of carbonaceous particulate material, or at least three different types of carbonaceous particulate material, or at least four different types of carbonaceous particulate material.

In certain embodiments, the carbonaceous particulate materials are selected from natural graphite, synthetic graphite, coke, exfoliated graphite, graphene, few-layer graphene, graphite fibres, nano-graphite, non-graphitic carbon, carbon black, petroleum- or coal based coke, glass carbon, carbon nanotubes, fullerenes, carbon fibres, hard carbon, graphitized fined coke, or mixtures thereof. Specific carbonaceous particulate materials include, but are not limited to exfoliated graphites as described in WO 2010/089326 (highly oriented grain aggregate graphite, or HOGA graphite), or as described in co-pending EP application no. 16 188 344.2 (wet-milled and dried carbonaceous sheared nano-leaves) filed on Sep. 12, 2016.

In certain embodiments, the precursor composition comprises graphite and carbon black, for example, conductive carbon black.

In certain embodiments, the precursor composition comprises at least one carbonaceous particulate material which is graphite, for example, natural graphite or synthetic graphite. In such embodiments, the precursor composition may additionally comprise carbon black, for example, conductive carbon black.

In certain embodiments, the carbon black has a BET SSA of less than about 100 m²/g, for example, from about 30 m²/g to about 80 m²/g, or from about 30 m²/g to about 60 m²/g, or from about 35 m²/g to about 55 m²/g, or from about 40 m²/g to about 50 m²/g. In other embodiments, the carbon black, when present as the second carbonaceous particulate, may have a BET SSA of less than about 1200 m²/g, for example, lower than about 1000 m²/g or lower than about 800 m²/g, or lower than about 600 m²/g, or lower than about 400 m²/g, or lower than about 200 m²/g.

In certain embodiments, the at least one carbonaceous particulate material is a synthetic graphite, for example, a surface-modified synthetic graphite. In certain embodiments, the surface-modified synthetic graphite comprises core particles with a hydrophilic non-graphitic carbon coating, having a BET SSA of less than about 49 m²/g, for example, less than about 25 m²/g, or less than about 10 m²/g. In such embodiments, the core particles are synthetic graphite particles, or a mixture of synthetic graphite particles and silicon particles. Such a material and the preparation thereof is described in WO 2016/008951, the entire contents of which are incorporated herein by reference. In certain embodiments, the at least one carbonaceous particulate is a surface modified carbonaceous particulate material according to any one of claims 1-10 of WO 2016/008951 as published on 21 Jan. 2016, or that made by or obtainable by a process according to any one of claims 11-17 of WO 2016/008951 as published on 21 Jan. 2016.

In certain embodiments, the carbon matrix has a BET SSA of lower than about 10 m²/g, and the carbon matrix comprises at least first and second carbonaceous particulate materials, wherein the BET SSA of the first carbonaceous particulate material is lower than the BET SSA of the second carbonaceous particulate material and the carbon matrix, wherein the BET SSA of the second carbonaceous particulate is higher than the BET SSA of the first carbonaceous particulate and the carbon matrix.

In certain embodiments, the carbon matrix has a BET SSA of from about 2.0 m²/g to about 9.0 m²/g, or from about 2.0 m²/g to about 8.0 m²/g, or from about 3.0 m²/g to about 7.0 m²/g, or from about 3.0 m²/g to about 6.5 m²/g, or from about 3.5 m²/g to about 6.0 m²/g, or from about 4.0 m²/g to about 6.0 m²/g, or from about 4.5 m²/g to about 6.0 m²/g, or from about 4.5 m²/g to about 5.5 m²/g, or from about 4.5 to about 5.0 m²/g, or from about 4.0 m²/g to about 5.0 m²/g.

The BET SSA of the first carbonaceous particulate material may be lower than the BET SSA of the second carbonaceous particulate material and the carbon matrix. In certain embodiments, the first carbonaceous particulate has a BET SSA of less than about 8.0 m²/g, for example, from about 1.0 m²/g to about 7.0 m²/g, or from about 2.0 m²/g to about 6.0 m²/g, or from about 2.0 m²/g to about 5.0 m²/g, or from about 2.0 m²/g to about 4.0 m²/g, or from about 2.0 m²/g to about 3.0 m²/g, or from about 3.0 m²/g to about 4.0 m²/g.

In certain embodiments, the first carbonaceous particulate has a particle size distribution as follows:
a d₉₀ of at least about 10 μm, for example, at least about 15 μm, or at least about 20 μm, or at least about 25 μm, or at least about 30 μm, optionally less than about 50 μm, or less than about 40 μm; and/or
a d₅₀ of from about 5 μm to about 20 μm, for example, from about 10 μm to about 20 μm, or from about 10 μm to about 15 μm, or from about 15 μm to about 20 μm; and/or
a d₁₀ of from about 2 μm to about 10 μm, for example, from about 3 μm to about 9 μm, or from about 3 μm to about 6 μm, or from about 5 μm μm to about 9 μm.

In certain embodiments, the first carbonaceous particulate has a relatively high spring back of at least about 20%, for example, at least about 30%, or at least about 40%, or at least about 50%, or at least about 60%. In certain embodiments, the first carbonaceous particulate has a spring back of from about 40% to about 70%, for example, from about 45% to about 65%, for example, from about 45% to about 55%, or from about 60% to about 70%, or from about 50% to about 60%.

In certain embodiments, the first carbonaceous particulate material is graphite, for example, synthetic graphite or natural graphite, or a mixture thereof. In certain embodiments, the first carbonaceous particulate material is a mixture of synthetic graphite materials.

In certain embodiments, the first carbonaceous particulate material is or comprises (e.g., in admixture with another carbonaceous particulate material) a surface-modified synthetic graphite, for example synthetic graphite which has been surface modified by either chemical vapour deposition (“CVD coating”) or by controlled oxidation at elevated temperatures. In certain embodiments, the synthetic graphite prior to surface-modification is characterized by characterized by a BET SSA of from about 1.0 to about 4.0 m²/g, and by exhibiting a ratio of the perpendicular axis crystallite size L_{c} (measured by XRD) to the parallel axis crystallite size Lₐ (measured by Raman spectroscopy), i.e. L_{c}/Lₐ of greater than 1. Following surface-modification, the synthetic graphite is characterized by an increase of the ratio between the crystallite size L_{c} and the crystallite size Lₐ. In other words, the surface-modification process lowers the crystallite size Lₐ without substantially affecting the crystallite size L_{c}.

In one embodiment, the surface-modification of the synthetic graphite is achieved by contacting the untreated synthetic graphite with oxygen at elevated temperatures for a sufficient time to achieve an increase of the ratio L_{c}/Lₐ, preferably to a ratio of >1, or even greater, such as >1.5, 2.0, 2.5 or even 3.0. Moreover, the process parameters such as temperature, amount of oxygen-containing process gas and treatment time are chosen to keep the burn-off rate relatively low, for example, below about 10%, below 9% or below 8%. The process parameters are selected so as to produce a surface-modified synthetic graphite maintaining a BET surface area of below about 4.0 m²/g.

The process for modifying the surface of synthetic graphite may involve a controlled oxidation of the graphite particles at elevated temperatures, such as ranging from about 500 to about 1100° C. The oxidation is achieved by contacting the synthetic graphite particles with an oxygen-containing process gas for a relatively short time in a suitable furnace such as a rotary furnace. The process gas containing the oxygen may be selected from pure oxygen, (synthetic or natural) air, or other oxygen-containing gases such as CO2, CO, H2O (steam), O3, and NOx. It will be understood that the process gas can also be any combination of the aforementioned oxygen-containing gases, optionally in a mixture with an inert carrier gas such as nitrogen or argon. It will generally be appreciated that the oxidation process runs faster with increased oxygen concentration, i.e., a higher partial pressure of oxygen in the process gas. The process parameters such as treatment time (i.e. residence time in the furnace), oxygen content and flow rate of the process gas as well as treatment temperature are chosen to keep the burn off rate below about 10% by weight, although it is in some embodiments desirable to keep the burn-off rate even lower, such as below 9%, 8%, 7%, 6% or 5%. The burn-off rate is a commonly used parameter, particularly in the context of surface oxidation treatments, since it gives an indication on how much of the carbonaceous material is converted to carbon dioxide thereby reducing the weight of the remaining surface-treated material.

The treatment times during which the graphite particles are in contact with the oxygen-containing process gas (e.g. synthetic air) may be relatively short, thus in the range of 2 to 30 minutes. In many instances the time period may be even shorter such as 2 to 15 minutes, 4 to 10 minutes or 5 to 8 minutes. Of course, employing different starting materials, temperatures and oxygen partial pressure may require an adaptation of the treatment time in order to arrive at a surface-modified synthetic graphite having the desired structural parameters as defined herein. Oxidation may be achieved by contacting the synthetic graphite with air or another oxygen containing gas at a flow rate generally ranging from 1 to 200 l/min, for example, from 1 to 50 l/min, or from 2 to 5 l/min. The skilled person will be able to adapt the flow rate depending on the identity of the process gas, the treatment temperature and the residence time in the furnace in order to arrive at a surface-modified graphite.

Alternatively, the synthetic graphite starting material is subjected to a CVD coating treatment with hydrocarbon-containing process gas at elevated temperatures for a sufficient time to achieve an increase of the ratio L_{c}/Lₐ, preferably to a ratio of >1, or even greater, such as >1.5, 2.0, 2.5 or even 3.0. Suitable process and surface-modified synthetic graphite materials are described in U.S. Pat. No. 7,115,221, the entire contents of which are hereby incorporated by reference. The CVD process coats the surface of graphite particles with mostly disordered (i.e., amorphous) carbon-containing particles. CVD coating involves contacting the synthetic graphite starting material with a process gas containing hydrocarbons or a lower alcohol for a certain 30 time period at elevated temperatures (e.g. 500° to 1000° C.). The treatment time will in most embodiments vary from 2 to 120 minutes, although in many instances the time during which the graphite particles are in contact with the process gas will only range from 5 to 90 minutes, from 10 to 60 minutes, or from 15 to 30 minutes. Suitable gas flow rates can be determined by those of skill in the art. In some embodiments, the process gas contains 2 to 10% of acetylene or propane in a nitrogen carrier gas, and a flow rate of around 1 m³/h.

In certain embodiments, the first carbonaceous particulate, for example, the surface-modified synthetic graphite as described in the preceding paragraphs, may have, in addition to the BET SSA, particle size distribution and spring back described above, one or more of the following properties:

an interlayer spacing c/2 (as measured by XRD) of equal to or less than about 0.337 nm, for example, equal to or less than about 0.336;

a crystallite size L_{c} (as measured by XRD) of from 100 nm to about 175 nm, for example, from about 140 nm to about 170 nm;

a xylene density of from about 2.22 to about 2.24 g/cm³, for example, from about 0.225 to about 0.235 g/cm³;

a Scott density of from about 0.25 g/cm³ to about 0.75 g/cm³, for example, from about 0.40 to about 0.50 g/cm³.

In certain embodiments, the first carbonaceous particulate is or comprises (e.g., in admixture with another carbonaceous particulate material) a synthetic graphite which has not been surface-modified, i.e., a non-surface-modified synthetic graphite. In addition to the BET SSA, particle size distribution and spring back described above, the non-surface modified synthetic particulate may have on or more of the following properties:

an interlayer spacing c/2 (as measured by XRD) of equal to or less than about 0.337 nm, for example, equal to or less than about 0.336;

a crystallite size L_{c} (as measured by XRD) of from 100 nm to about 150 nm, for example, from about 120 nm to about 135 nm;

a xylene density of from about 2.23 to about 2.25 g/cm³, for example, from about 0.235 to about 0.245 g/cm³;

a Scott density of from about 0.15 g/cm³ to about 0.60 g/cm³, for example, from about 0.30 to about 0.45 g/cm³.

In certain embodiments, the non-surface-modified synthetic graphite is prepared according to the methods described in WO 2010/049428, the entire contents of which are hereby incorporated by reference.

In certain embodiments, the first carbonaceous particulate is a mixture of the surface-modified synthetic graphite described here and the non-surface modified synthetic graphite described herein. The weight ratio of the such a mixture may vary from 99:1 to about 1:99 ([surface modified]:[non-surface-modified]), for example, from about 90;10 to about 10:90, or from about 80:20 to about 20:80, or from about 70:30 to about 30:70, or from about 60:40 to about 40:60, or from about 50:50 to about 30:70, or from about 45:55 to about 35:65.

Relative to the first carbonaceous particulate material, the additional carbonaceous particulate materials have a higher BET SSA and/or lower spring back, for example, a higher BET SSA and lower spring back.

The BET SSA of the second carbonaceous particulate material is higher than the BET SSA of the first carbonaceous particulate material and the carbon matrix and, when, present, the BET SSA of the third carbonaceous particulate material is higher than the BET SSA of the second carbonaceous particulate material and, when present, the BET SSA of a fourth carbonaceous particulate material is higher than the BET SSA of the third carbonaceous particulate material.

### Embodiment A

In certain embodiments, the second carbonaceous particulate material has a BET SSA higher than about 8 m²/g and lower than about 20 m²/g, for example, lower than about 15 m²/g, or lower than about 12 m²/g, or lower than about 10 m²/g. In such embodiments, the third carbonaceous particulate material, when present, has a BET SSA higher than about 20 m²/g, for higher than about 25 m²/g, or higher than about 30 m²/g, optionally lower than about 40 m²/g, for example, lower than about 35 m²/g. example. In such embodiments, the second or third, when present, or both of the second and third carbonaceous particulate materials, may have a spring back of less than 20%, for example, less than about 18%, or less than about 16%, or less than about 14%, or equal to or less than about 12%, or equal to or less than about 10%. In such embodiments, the precursor composition may comprise a fourth carbonaceous particulate material having a BET SSA of at least about 40 m²/g and lower than about 100 m²/g, for example, lower than about 80 m²/g, or lower than about 60 m²/g, or lower than about 50 m²/g. In such embodiments, the fourth carbonaceous particulate may be carbon black. In other embodiments, the carbon black, when present as the fourth carbonaceous particulate, may have a BET SSA of less than about 1200 m²/g, for example, lower than about 1000 m²/g or lower than about 800 m²/g, or lower than about 600 m²/g, or lower than about 400 m²/g, or lower than about 200 m²/g.

In certain embodiments of Embodiment A, which may be referred to as Embodiment A1, the third carbonaceous particulate is not present, in which case the fourth carbonaceous particulate may be regarded as the third carbonaceous particulate material.

In certain embodiments, the second carbonaceous particulate material has a particle size distribution as follows:

a d₉₀ of at least about 8 μm, for example, at least about 10 μm, or at least about 12 μm, optionally less than about 25 μm, or less than about 20 μm; and/or

a d₅₀ of from about 5 μm to about 12 μm, for example, from about 5 μm to about 10 μm, or from about 7 μm to about 9 μm; and/or

a d₁₀ of from about 1 μm to about 5 μm, for example, from about 2 μm to about 5 μm, or from about 3 μm to about 5 μm, or from about 3 μm μm to about 4 μm.

In Embodiment A and A1, the second carbonaceous particulate may be a carbonaceous material that has not undergone any surface modification, such as coating with non-graphitic carbon or surface oxidation. On the other hand, the term unmodified in this context still allows purely mechanical manipulation of the carbonaceous particles because the particles in many embodiments may need to be milled or otherwise subjected to other mechanical forces, for example in order to obtain the desired particle size distribution.

In some embodiments, the second carbonaceous particulate material is natural or synthetic graphite, optionally a highly crystalline graphite. As used herein, “highly crystalline” preferably refers to the crystallinity of the graphite particles characterized by the interlayer distance c/2, by the real density (xylene density), and/or the size of the crystalline domains in the particle (crystalline size Lc). In such embodiments, a highly crystalline carbonaceous material may be characterized by a c/2 distance of ≤0.3370 nm, or ≤0.3365 nm, or ≤0.3362 nm, or ≤0.3360 nm, and/or by a xylene density above 2.230 g/cm³, and/or by an Lc of at least 20 nm, or at least 40 nm, or at least 60 nm, or at least 80nm, or at least 100 nm, or more.

In addition to the BET SSA, particle size distribution and spring back described above, the second carbonaceous particulate material may have on or more of the following properties:

a crystallite size L_{c} (as measured by XRD) from 100 to 300 nm, or from 100 nm to 250 nm, or from 100 nm to 200 nm, or from 150 nm to 200 nm;

a Scott density of less than about 0.2 g/cm³, or less than about 0.15 g/cm³, or less than about 0.10 g/cm³, optionally greater than about 0.05 g/cm³;

a xylene density from 2.24 to 2.27 g/cm³, or from 2.245 to 2.26 g/cm³, or from 2.245 and 2.255 g/cm³.

In certain embodiments, the second carbonaceous particulate material is a non-surfaced-modified synthetic graphite. For the avoidance of doubt, such a non-surfaced-modified synthetic graphite is distinct from the non-surfaced-modified synthetic graphite described in embodiments pertaining to the first carbonaceous particulate material.

In certain embodiments, the non-surface modified synthetic graphite may be made by graphitization of a petroleum based coke at temperatures above about 2500° C. under an inert gas atmosphere and then milled or ground to the appropriate particle size distribution. Alternatively, the second carbonaceous particulate may be grinding or milling a chemically or thermally purified natural flake graphite to the appropriate particle size distribution.

In Embodiment A, but not A1, the third carbonaceous particulate material, when present, may be as defined below as the second carbonaceous particulate material in Embodiment B.

In addition to the BET SSA described above, the fourth carbonaceous particulate material of Embodiment A, the third carbonaceous particulate material of Embodiment A1, and the third carbonaceous particulate material of Embodiment B below, may be further characterized by having one or more of the following properties:

a crystallite size L_{c} (as measured by XRD) of less than 20 nm, for example, less than 10 nm, or less than 5 nm, or less than 4 nm, or less than 3 nm, optionally at least 0.5 nm, or at least 1 nm;

a Scott density of less than about 0.2 g/cm³, or less than about 0.15 g/cm³, or less than about 0.10 g/cm³, or less than about 0.08 g/cm³, or less than about 0.06 g/cm³, optionally greater than about 0.05 g/cm³;

a xylene density of less than about 2.20 g/cm³, for example, less than about 0.15 g/cm³, optionally greater than about 2.10 g/cm³, for example, from about 2.11 to about 2.15 g/cm³, or from about 2.12 to about 2.14 g/cm³, or from about 2.125 to about 2.135 g/cm³.

### Embodiment B

In certain embodiments, the second carbonaceous particulate material has a BET SSA higher than about 20 m²/g, for example, higher than about 25 m²/g, or higher than about 30 m²/g, optionally lower than about 40 m²/g, for example, lower than about 35 m²/g. In such embodiments, the second carbonaceous particulate material may have a spring back of less than 20%, for example, less than about 18%, or less than about 16%, or less than about 14%, or equal to or less than about 12%, or equal to or less than about 10%. In such embodiments, a further carbonaceous particulate may be present as a third carbonaceous particulate. The third carbonaceous particulate material may have a BET SSA of at least about 40 m²/g and lower than about 100 m²/g, for example, lower than about 80 m²/g, or lower than about 60 m²/g, or lower than about 50 m²/g. In such embodiments, the third carbonaceous particulate may be carbon black. In other embodiments, the carbon black, when present as the third carbonaceous particulate, may have a BET SSA of less than about 1200 m²/g, for example, lower than about 1000 m²/g or lower than about 800 m²/g, or lower than about 600 m²/g, or lower than about 400 m²/g, or lower than about 200 m²/g.

In certain embodiments of Embodiment B, the second carbonaceous particulate material may be graphite, for example, natural or synthetic graphite. In certain embodiments, the second carbonaceous particulate material is natural graphite. In certain embodiments, the natural graphite is an exfoliated graphite. In certain embodiments, the second carbonaceous particulate material is synthetic graphite. In certain embodiments, the synthetic graphite is an exfoliated graphite. In some embodiments, the second carbonaceous particulate material is an exfoliated graphite as described in WO 2010/089326 (highly oriented grain aggregate graphite, or HOGA graphite), or as described in co-pending EP application no. 16 188 344.2 (wet-milled and dried carbonaceous sheared nano-leaves) filed on Sep. 12, 2016.

In certain embodiments, the second carbonaceous particulate material of Embodiment B has a particle size distribution as follows:

a d₉₀ of at least about 4 μm, for example, at least about 6 μm, or at least about 8 μm, optionally less than about 15 μm, or less than about 12 μm; and/or

a d₅₀ of from about 2 μm to about 10 μm, for example, from about 5 μm to about 10 μm, or from about 6 μm to about 9 μm; and/or

a d₁₀ of from about 0.5 μm to about 5 μm, for example, from about 1 μm to about 4 μm, or from about 1 μm to about 3 μm, or from about 1.5 μm μm to about 2.5 μm.

In addition to the BET SSA, particle size distribution and spring back described above, the second carbonaceous particulate material may have on or more of the following properties:

a crystallite size L_{c} (as measured by XRD) from 5 to 75 nm, or from 10 nm to 50 nm, or from 20 nm to 40 nm, or from 20 nm to 35 nm, or 20 to 30 nm, or 25 to 35 nm;

a Scott density of less than about 0.2 g/cm³, or less than about 0.15 g/cm³, or less than about 0.10 g/cm³, or less than about 0.08 g/cm³, optionally greater than about 0.04 g/cm³;

a xylene density from 2.24 to 2.27 g/cm³, or from 2.245 to 2.26 g/cm³, or from 2.245 and 2.255 g/cm³.

### Embodiment C

In certain embodiments, the second carbonaceous particulate material has a BET SSA of at least about 40 m²/g and lower than about 100 m²/g, for example, lower than about 80 m²/g, or lower than about 60 m²/g, or lower than about 50 m²/g. In such embodiments, the second carbonaceous particulate may be carbon black. The second carbonaceous particulate material of Embodiment C may be the same material as the fourth carbonaceous particulate material of Embodiment A.

Based on the total weight of carbonaceous particulate material in the precursor composition (i.e., the carbon matrix), the first carbonaceous particulate material may be present in an amount up to about 99 wt. %, for example, from about 50 wt. % to about 99 wt. %, or from about 60 wt. % to about 98 wt. %, or from about 70 wt. % to about 95 wt. %, or from about 80 wt. % to about 95 wt. %, or from about 90 wt. % to about 95 wt. %, with the balance one or more of the other carbonaceous particulate materials described herein.

In certain embodiments, the second carbonaceous particulate material and, when present, third carbonaceous particulate material, may be present in amount up to about 10 wt. % of each (i.e., up to 20 wt. % in total), based on the total weight of the carbonaceous particulate material, for example, up to about 8 wt. % (of each), or up to about 6 wt. % (of each), or up to about 4 wt. % (of each), or up to about 2 wt. % (of each).

In certain embodiments, the precursor composition comprises at least about 1 wt. % of a second carbonaceous particulate.

In certain embodiments, for example, certain embodiments of Embodiment A, the precursor composition comprises up to about 90 wt. % of the first carbonaceous particulate material, from 1-10 wt. % of the second carbonaceous particulate material, from 1-10 wt. % of the third carbonaceous particulate material, when present, and from 1-5 wt. % of the fourth carbonaceous particulate material, when present.

In certain embodiments of Embodiment A, the precursor composition comprises at least about 80 wt. % of the first carbonaceous particulate material, from 2-10 wt. % of the second carbonaceous material, and from 2-10 wt. % of the third carbonaceous particulate material, for example, at least about 85 wt. % of the first carbonaceous particulate material, from 5-9 wt. % of the second carbonaceous particulate material, and from 5-9 wt. % of the third carbonaceous particulate material.

In certain embodiments of Embodiment Al, the precursor composition comprises at least about 85 wt. % of the first carbonaceous particulate material, from 2-10 wt. % of the second carbonaceous material, and from 1-5 wt. % of the third carbonaceous particulate material.

In certain embodiments of Embodiment A, the carbonaceous particulate material consists of the first carbonaceous particulate material and the second carbonaceous material, wherein the amount of first carbonaceous particulate material may be at least 80 wt. %, based on the total weight of the carbonaceous particulate material in the precursor composition, and the amount of the second carbonaceous particulate may be up to about 20 wt. %, for example, at least about 90 wt. % of the first carbonaceous particulate material and up to about 10 wt. % of the second carbonaceous particulate material, or at least about 95 wt. % of the first carbonaceous particulate material and up to about 5 wt. % of the second carbonaceous particulate material.

In certain embodiments of Embodiment B, the precursor composition comprises up to about 90 wt. % of the first carbonaceous particulate material, from 1-10 wt. % of the second carbonaceous particulate material, and from 1-5 wt. % of the fourth carbonaceous particulate material, when present.

In certain embodiments of Embodiment B, the carbonaceous particulate material consists of the first carbonaceous particulate material and the second carbonaceous material, wherein the amount of first carbonaceous particulate material may be at least 80 wt. %, based on the total weight of the carbonaceous particulate material in the precursor composition, and the amount of the second carbonaceous particulate may be up to about 20 wt. %, for example, at least about 90 wt. % of the first carbonaceous particulate material and up to about 10 wt. % of the second carbonaceous particulate material, or at least about 95 wt. % of the first carbonaceous particulate material and up to about 5 wt. % of the second carbonaceous particulate material.

In the various ‘Precursor composition’ embodiments described above, the first carbonaceous particulate may be a mixture of the surface-modified synthetic graphite described here and the non-surface modified synthetic graphite described herein. The weight ratio of the such a mixture may vary from 99:1 to about 1:99 ([surface modified]:[non-surface-modified]), for example, from about 90;10 to about 10:90, or from about 80:20 to about 20:80, or from about 70:30 to about 30:70, or from about 60:40 to about 40:60, or from about 50:50 to about 30:70, or from about 45:55 to about 35:65.

In the various ‘Precursor composition’ embodiments described above, the first carbonaceous particulate may constitute a single material rather than a mixture. For example, in certain embodiments, the first carbonaceous particulate material is the surface-modified synthetic graphite described herein. In other embodiments, the first carbonaceous particulate material is the non-surface-modified synthetic graphite described herein.

In certain embodiments, any of the first, second, third and fourth carbonaceous particulates described herein may be used individually in the in the precursor composition along with the silicon particulate. Other combinations of the first, second, third and fourth carbonaceous particulate materials that are not described explicitly herein are contemplated also.

The amount of the silicon particulate active material present in the precursor composition may be based on the total weight of the precursor composition or the total weight of the negative electrode which is made from the precursor composition, i.e., based on the total weight of the negative electrode.

In certain embodiments, the precursor composition comprises from about 0.1 wt. % to about 90 wt. % of silicon particulate active material, based on the total weight of the precursor composition, for example, from about 0.1 wt. % to about 80 wt. %, or from about 0.1 wt. % to about 70 wt. %, or from about 0.1 wt. % to about 60 wt. %, or from about 0.1 wt. % to about 50 wt. %, or from about 0.1 wt. % to about 40 wt. %, or from about 0. 5 wt. % to about 30 wt. %, or from about 1 wt. % to about 25 wt.%, or from about 1 wt. % to about 20 wt. %, or from about 1 wt. % to about 15 wt. %, or from about 1 wt. to about 10 wt. %, or from about 1 wt. % to about 5 wt.%.

In certain embodiments, the precursor composition comprises from about 1 wt. % to about 90 wt. % of silicon particulate active material, based on the total weight of the negative electrode, for example, from about 1 wt. % to about 80 wt. %, or from about 1 wt. % to about 70 wt. %, or from about 1 wt. % to about 60 wt. %, or from about 1 wt. % to about 50 wt. %, or from about 1 wt. % to about 40 wt. %, or from about 2 wt. % to about 30 wt. %, or from about 5 wt. % to about 25 wt. %, or from about 7.5 wt. % to about 20 wt. %, or from about 10 wt. to about 17.5 wt. %, or from about 12.5 wt.% to about 15 wt.%.

In certain embodiments, the carbon matrix constitutes up to about 99 wt. % of the precursor composition, based on the total weight of the precursor, for example, up to about 95 wt. %, or up to about 90 wt. %, or up to about 85 wt. %, or up to about 80 wt. %, or up to about 75 wt. %, or up to about 70 wt. %, or up to about 65 wt. %, or up to about 60 wt. %. Up to about 5 wt. % of the carbon matrix may be carbon black, for example, conductive carbon black, for example, up to about 4 wt. %, or up to about 3 wt. %, or up to about 2 wt. %, or up to about 2 wt. %.

The precursor composition may be made by mixing the carbonaceous particulates in suitable amounts forming the carbon matrix optionally together with the silicon particulate active material. In certain embodiments, the carbon matrix is prepared, and then the active material is combined with the carbon matrix, again, using any suitable mixing technique. In certain embodiments, the carbon matrix is prepared at a first location and then combined with the active material in a second location. In certain embodiments, a carbon matrix is prepared in a first location and then transported to a second location (e.g., an electrode manufacturing site) where it is combined with active material and optionally additional carbonaceous particulate if desired, and then with any additional components to manufacture a negative electrode therefrom, as described below.

In certain embodiments, the carbonaceous particulate(s) and, thus, the carbon matrix, is selected such that the precursor composition has a microporosity which is lower than the silicon particulate. In certain embodiments, the precursor composition has a microporosity of at least about 5%, for example, from about 5% to about 20%, or from about 5% to about 10%, or from about 5% to lower than 5%, subject to the proviso that it is lower than the microporosity of the silicon particulate.

In certain embodiments, the precursor composition has one or more of:
(i) a BJH volume of pores which is greater than the silicon particulate, or
(ii) a BJH volume of pores which is lower than the silicon particulate, or
(iii) a BJH average pore width which is higher than the silicon particulate, or
(iv) a BJH average pore width which is lower than the silicon particulate.

In certain embodiments, the precursor composition has (i) and (iii), or (i) and (iv), or it has (ii) and (iii), or (ii) and (iv), respectively.

### Negative Electrode for a Li-Ion Battery

The precursor compositions as defined herein can be used for manufacturing negative electrodes for Li-ion batteries, in particular Li-ion batteries empowering electric vehicles, or hybrid electric vehicles, or energy storage units.

Thus, another aspect is a negative electrode for a Li-ion battery comprising a silicon particulate as defined herein, manufactured from a precursor composition as defined herein.

In a related aspect, there is provided a negative electrode comprising at least 1 wt. % of a silicon particulate as defined herein, based on the total weight of the electrode, and optionally having a carbon matrix having a BET SSA of lower than about 10 m²/g.

In certain embodiments, the negative electrode of these aspects comprises at least about 2 wt. %, for example, at least about 5 wt. %, or at least about 10 wt. %, and optionally up to about 90 wt. % of the silicon particulate active material, based on the total weight of the electrode, for example, up to about 80 wt. %, or up to about 70 wt. %, or up to about 60 wt. %, or up to about 50 wt. %, or up to about 40 wt. %. In certain embodiments, the negative electrode comprises from about 5 wt. % to about 35 wt. silicon particulate, based on the total weight of the electrode, for example, from about 5 wt. % to about 30 wt. %, or from about 5 wt. % to about 25 wt. %, or from about 10 wt. % to about 20 wt. %, or from about 10 wt. % to about 18 wt. %, or from about 12 wt. % to about 16 wt. %, or from about 13 wt. % to about 15 wt. %. In certain embodiments, the silicon particulate is manufactured from elemental silicon, for example, elemental silicon having a purity of at least about 95%, or at least about 98%, optionally, less than about 99.99%, or less than about 99.9%, or less than about 99%.

The negative electrode may be manufactured using conventional methods. In certain embodiments, the precursor composition is combined with a suitable binder. Suitable binder materials are many and various and include, for example, cellulose, acrylic or styrene-butadiene based binder materials such as, for example, carboxymethyl cellulose and/or PAA (polyacrylic acid) and/or styrene-butadiene rubber. The amount of binder may vary. The amount of binder may be from about 1 wt. to about 20 wt. %, based on the total weight of the negative electrode, for example, from about 1 wt. % to about 15 wt. %, or from about 5 wt. % to about 10 wt. %, or from about 1 wt. % to about 5 wt. %, or from about 2 wt. % to about 5 wt. %, or from about 3 wt. % to about 5 wt. %.

The negative electrode may then be used in a Li-ion battery.

In certain aspects, therefore, there is provided a Li-ion battery comprising a negative electrode wherein (i) silicon pulverization does not occur during 1^{st} cycle lithium interaction and de-intercalation and/or (ii) electrochemical capacity is maintained after 100 cycles. In a related aspect, the Li-ion battery comprises a silicon particulate as defined herein, optionally further comprising a carbon matrix as defined herein.

As described above, the Li-ion battery may be incorporated in a device requiring power. In certain embodiments, the device is an electric vehicle, for example, a hybrid electric vehicle or a plug-in electric vehicle.

In certain embodiments, the precursor composition is incorporated in an energy storage device. In certain embodiments, the silicon particulate and/or precursor composition is incorporated in an energy storage and conversion system, for example, an energy storage and conversion system which is or comprises a capacitor, or a fuel cell.

In other embodiments, the carbon matrix is incorporated in a carbon brush or friction pad.

In other embodiments, the precursor composition is incorporated within a polymer composite material, for example, in an amount ranging from about 5-95 wt. %, or 10-85%, based on the total weight of the polymer composite material.

### Uses

In related aspects and embodiments, there is provided the use of a silicon particulate as active material in a negative electrode of a Li-ion battery to inhibit or prevent silicon pulverization during cycling, for example, during 1^{st} cycle Li intercalation and de-intercalation, and/or to maintain electrochemical capacity after 100 cycles. In certain embodiments, the silicon particulate is a silicon particulate according to the first aspect. In certain embodiments, Li is electrochemically extracted from an amorphous lithium silicon phase and in the substantial absence of two crystalline phases containing crystalline silicon metal and crystalline Li₁₅Si₄ alloy

In another embodiments, the silicon particulate of the first aspect is used as active material in negative electrode of a Li-ion battery for improving the cycling stability of the Li-ion battery compared to a Li-ion battery which comprises a silicon particulate which is not wet-milled and/or does not have a nanostructure which inhibits or prevents silicon pulverization during cycling, for example, during 1st cycle Li intercalation, and/or does not have a nanostructure which maintains electrochemical capacity after 100 cycles.

### Measurement Methods

### BET Specific Surface Area (BET SSA)

The method is based on the registration of the absorption isotherm of liquid nitrogen in the range p/p₀=0.04-0.26, at 77 K. Following the procedure proposed by Brunauer, Emmet and Teller (Adsorption of Gases in Multimolecular Layers, J. Am. Chem. Soc., 1938, 60, 309-319), the monolayer adsorption capacity can be determined. On the basis of the cross-sectional area of the nitrogen molecule, the monolayer capacity and the weight of the sample, the specific surface area can then be calculated.

Meso- and macro-porosity parameters, including average pore width and total volume of pores, were derived from the nitrogen adsorption data using the Barrett-Joyner-Halenda (BJH) theory and microporosity in relation to the total BET surface area was determined using the t-plot method. The average particle size was calculated from the BET surface area assuming nonporous spherical particles and the theoretical density of silicon (2.33 g/cm³).

### X-Ray Diffraction

XRD data were collected using a PANalytical X′Pert PRO diffractometer coupled with a PANalytical X′Celerator detector. The diffractometer has the following characteristics shown in Table 1:

TABLE 1
Instrument data and measurement parameters

| | |
|---|---|
| Instrument | PANalytical X'Pert PRO |
| X-ray detector | PANalytical X'Celerator |
| X-ray source | Cu—Kₐ |
| Generator | 45 kV-40 mA |
| parameters | |
| Scan speed | 0.07°/s (for L_{c} and c/2) |
| | 0.01°/s (for [004]/[110] ratio) |
| Divergence slit | 1° (for L_{c} and c/2) |
| | 2° (for [004]/[110] ratio) |
| Sample spinning | 60 rpm |

The data were analyzed using the PANalytical X′Pert HighScore Plus software.

### Interlayer Spacing c/2

The interlayer space c/2 is determined by X-ray diffractometry. The angular position of the peak maximum of the [002] reflection profiles are determined and, by applying the Bragg equation, the interlayer spacing is calculated (Klug and Alexander, X-ray Diffraction Procedures, John Wiley & Sons Inc., New York, London (1967)). To avoid problems due to the low absorption coefficient of carbon, the instrument alignment and non-planarity of the sample, an internal standard, silicon powder, is added to the sample and the graphite peak position is recalculated on the basis of the position of the silicon peak. The graphite sample is mixed with the silicon standard powder by adding a mixture of polyglycol and ethanol. The obtained slurry is subsequently applied on a glass plate by means of a blade with 150 μm spacing and dried.

### Crystallite Size L_{c}

Crystallite size L_{c} is determined by analysis of the [002] X-ray diffraction profiles and determining the widths of the peak profiles at the half maximum. The broadening of the peak should be affected by crystallite size as proposed by Scherrer (P. Scherrer, Göttinger Nachrichten 1918, 2, 98). However, the broadening is also affected by other factors such X-ray absorption, Lorentz polarization and the atomic scattering factor. Several methods have been proposed to take into account these effects by using an internal silicon standard and applying a correction function to the Scherrer equation. For the present disclosure, the method suggested by Iwashita (N. Iwashita, C. Rae Park, H. Fujimoto, M. Shiraishi and M. Inagaki, Carbon 2004, 42, 701-714) was used. The sample preparation was the same as for the c/2 determination described above.

### Crystallite Size Lₐ

Crystallite size Lₐ is calculated from Raman measurements (performed at external lab Evans Analytical Group) using equation:

Lₐ[Angstrom(Å)]=C×(I_{G}/I_{D})

where constant C has values 44[Å] and 58[Å] for lasers with wavelength of 514.5 nm and 632.8 nm, respectively.

### Xylene Density

The analysis is based on the principle of liquid exclusion as defined in DIN 51 901. Approx. 2.5 g (accuracy 0.1 mg) of powder is weighed in a 25 ml pycnometer. Xylene is added under vacuum (20 mbar). After a few hours dwell time under normal pressure, the pycnometer is conditioned and weighed. The density represents the ratio of mass and volume. The mass is given by the weight of the sample and the volume is calculated from the difference in weight of the xylene filled pycnometer with and without sample powder.
Reference: DIN 51 901

### Scott Density (Apparent Density)

The Scott density is determined by passing the dry powder through the Scott volumeter according to ASTM B 329-98 (2003). The powder is collected in a 1 in 3 vessel (corresponding to 16.39 cm³) and weighed to 0.1 mg accuracy. The ratio of weight and volume corresponds to the Scott density. It is necessary to measure three times and calculate the average value. The bulk density is calculated from the weight of a 250 mL sample in a calibrated glass cylinder.
Reference: ASTM B 329-98 (2003)

### Spring-Back

Spring-back is a source of information regarding the resilience of compacted powders. A defined amount of powder is poured into a die. After inserting the punch and sealing the die, air is evacuated from the die. A compression force of 0.5 tons/cm² is applied and the powder height is recorded. This height is recorded again after the pressure has been released. Spring-back is the height difference in percent relative to the height under pressure.

### Particle Size Distribution by Laser Diffraction (wet PSD)

The presence of particles within a coherent light beam causes diffraction. The dimensions of the diffraction pattern are correlated with the particle size. A parallel beam from a low-power laser lights up a cell which contains the sample suspended in water. The beam leaving the cell is focused by an optical system. The distribution of the light energy in the focal plane of the system is then analyzed. The electrical signals provided by the optical detectors are transformed into particle size distribution by means of a calculator. A small sample of silicon dispersion or dried silicon is mixed with a few drops of wetting agent and a small amount of water. The sample is prepared in the described manner and measured after being introduced in the storage vessel of the apparatus filled with water that uses ultrasonic waves for improving dispersion.
References: -ISO 13320-1/-ISO 14887

### Particle Size Distribution by Laser Diffraction (Dry PSD)

The Particle Size Distribution is measured using a Sympatec HELOS BR Laser diffraction instrument equipped with RODOS/L dry dispersion unit and VIBRI/L dosing system. A small sample is placed on the dosing system and transported using 3 bars of compressed air through the light beam. The particle size distribution is calculated and reported in μm for the three quantiles: 10%, 50% and 90%.
References: ISO 13320-1

### Lithium-Ion Negative Electrode Half Cell Test

This test was used to quantify the specific charge of nano-Si/carbon-based electrodes.
General half-cell parameters: 2 electrode coin cell design with Li metal foil as counter/reference electrode, cell assembly in an argon filled glove box (oxygen and water content <1 ppm).
Diameter of electrodes: 13 mm. A calibrated spring (100 N) was used in order to have a defined force on the electrode. Tests were carried out at 25° C.
Electrode loading on copper electrode: 6 mg/cm². Electrode density: 1.3 g/cm³.
Drying procedure: Coated Cu foils were dried for 1 h at 80° C., followed by 12 h at 150° C. under vacuum (<50 mbar). After cutting, the electrodes were dried for 10 h at 120° C. under vacuum (<50 mbar) before insertion into the glove box.
Electrolyte: Ethylenecarbonate (EC): Ethylmethylcarbonate (EMC) 1:3 (v/v), 1 M LiPF₆, 2% fluoroethylene carbonate, 0.5% vinylene carbonate. Separator: Glass fiber sheet, ca. 1 mm.
Cycling program using a potentiostat/galvanostat: 1^{st} charge: constant current step 20 mA/g to a potential of 5 mV vs. Li/Li⁺, followed by a constant voltage step at 5 mV vs. Li/Li⁺ until a cutoff current of 5 mA/g was reached. 1^{st} discharge: constant current step 20 mA/g to a potential of 1.5 V vs. Li/Li⁺, followed by a constant voltage step at 1.5 V vs. Li/Li⁺ until a cutoff current of 5 mA/g was reached.
Further charge cycles: constant current step at 50 mA/g to a potential of 5 mV vs. Li/Li⁺, followed by a constant voltage step at 5 mV vs. Li/Li⁺ until a cutoff current of 5 mA/g was reached. Further discharge cycles: constant current step at 372 mA/g to a potential of 1.5 V vs. Li/Li⁺, followed by constant voltage step at 1.5 V vs. Li/Li⁺ until a cutoff current of 5 mA/g was reached.

### Numbered Embodiments

The present disclosure may be further illustrated by, but is not limited to, the following numbered embodiments:
1. A silicon particulate suitable for use as active material in a negative electrode of a Li-ion battery, having one or more of:
   (i) a microporosity of at least 10%,
   (ii) a BJH average pore width of from about 110 to 200 Å, and
   (iii) a BJH volume of pores of at least about 0.32 cm³/g.
2. The silicon particulate according to embodiment 1, wherein:
   a. the percentage of the total pore volume which resides in pores having a pore width of from 400 Å to 800 Å is greater than the percentage of the total pore volume which resides in pores having a pore width of greater than 800 Å to 1200 Å, and/or
   b. the maximum pore volume contribution is at a pore width of between about 300 and about 500 Å, or between about 300 and about 400 Å, or between about 400 and about 500 Å.
3. The silicon particulate according to embodiment 1 or 2, wherein the silicon particulate has a BET SSA of at least about 70 m²/g, and/or an average particle size of less than about 750 Å.
4. A silicon particulate having a nanostructure which
   (i) inhibits or prevents silicon pulverization when used as active material in a negative electrode of a Li-ion battery; and/or
   (ii) maintains electrochemical capacity of a negative electrode.
5. The silicon particulate according to any one of embodiments 1-4, wherein the silicon particulate is a milled silicon particulate.
6. A precursor composition for a negative electrode of a Li-ion battery, the precursor composition comprising a silicon particulate according to any preceding embodiment and a carbonaceous particulate.
7. The precursor composition according to embodiment 6, wherein the composition comprises at least two different types of carbonaceous particulate, for example, at least three different types of carbonaceous particulate.
8. The precursor composition according to embodiment 6 or 7, wherein the carbonaceous particulate(s) is selected such that the precursor composition has a microporosity which is lower than the silicon particulate
9. The precursor composition according to any one of embodiments 6-8, wherein the precursor composition has a microporosity of at least about 5%.
10. Electrode comprising the silicon particulate according to any one of embodiments 1-5.
11. Electrode comprising the precursor composition according to any one of embodiments 6-9.
12. Li-ion battery comprising an electrode according to embodiment 10 or 11, optionally wherein (i) silicon pulverization does not occur during 1^{st} cycle lithium interaction and de-intercalation and/or (ii) electrochemical capacity is maintained after 100 cycles.
13. Li-ion battery comprising a negative electrode which comprises a silicon particulate as active material, wherein (i) silicon pulverization does not occur during 1^{st} cycle lithium intercalation and de-intercalation and/or (ii) electrochemical capacity is maintained after 100 cycles.
14. Use of a silicon particulate as active material in a negative electrode of a Li-ion battery to inhibit or prevent silicon pulverization during cycling, for example, during 1^{st} cycle Li intercalation and de-intercalation, and/or to maintain electrochemical capacity after 100 cycles.
15. Use according to embodiment 14, wherein the silicon particulate is a silicon particulate according to any one of embodiments 1-5.
16. Use according to embodiment 14 or 15, wherein Li is electrochemically extracted from an amorphous lithium silicon phase and in the substantial absence of two crystalline phases containing crystalline silicon metal and crystalline Li₁₅Si₄.alloy.
17. Use, as active material in negative electrode of a Li-ion battery, of a silicon particulate according to any one of embodiments 1-5, for improving the cycling stability of the Li-ion battery compared to a Li-ion battery which comprises a silicon particulate which is not milled and/or does not have a nanostructure which inhibits or prevents silicon pulverization during cycling, for example, during 1st cycle Li intercalation, and/or does not have a nanostructure which maintains electrochemical capacity after 100 cycles.
18. Use of a carbonaceous particulate material in a negative electrode of a Li-ion battery, wherein the electrode comprises a silicon particulate according to any one of embodiments 1-5.
19. A method of making a silicon particulate, comprising wet-milling a silicon starting material under conditions to produce a milled silicon particulate have a nanostructure which inhibits or prevents silicon pulverization when used as active material in a negative electrode of a Li-ion battery and/or which maintains electrochemical capacity of a negative electrode.
20. The method according to embodiment 19, wherein the silicon starting material is a micronized silicon particulate having a particle size of from about 1 μm to about 100 μm, for example, from about 1 μm to about 10 μm.
21. The method according to embodiment 19 or 20, wherein the method comprises one or more of the following:
   (i) wet-milling in the presence of a solvent, preferably in an aqueous alcohol-containing mixture,
   (ii) wet-milling in a rotor-stator mill, a colloidal mill or a media mill,
   (iii) wet-milling under conditions of high shear and/or high power density,
   (iv) wet-milling in the presence of relatively hard and dense milling media, and
   (v) drying.
22. The method according to any one of embodiments 19-21, wherein milling is conducted in the presence of a milling media having a density of at least about 3.0 g/cm³, for example, at least about 5.0 g/cm³, optionally wherein the milling media has a size of less than about 10 mm, for example, less than about 1 mm.
23. The method according to any one of embodiments 21-22, wherein the solvent is an aqueous alcohol-containing mixture comprising water and isopropanol.
24. The method according to any one of embodiments 21-23, wherein milling is conducted in a media mill.
25. The method according to any one of embodiments 19-24, wherein the power density during milling is at least about 2.5 kW/l.
26. A method of preparing a precursor composition for a negative electrode of a Li-ion battery, comprising preparing, obtaining, providing or supplying a silicon particulate according to any one of embodiments 1-5 or obtainable by a method according to any one of embodiments 19-25, and combining with a carbonaceous particulate.
27. A method of preparing a precursor composition for a negative electrode of a Li-ion battery, comprising, preparing, obtaining, providing or supplying a carbonaceous particulate and combining with a silicon particulate according to any one of embodiments 1-5.
28. A method of preparing a precursor composition for a negative electrode of a Li-ion battery, comprising combining a silicon particulate according to any one of embodiments 1-5 or obtainable by a method according to any one of embodiments 19-25 with a carbonaceous particulate.
29. The method according to any one of embodiments 25-27, wherein the carbonaceous particulate is prepared at a first location and combined with the silicon particulate at a second location.
30. The method according to any one of embodiments 25-27, wherein the carbonaceous particulate and milled silicon particulate are prepared and combined at the same location.
31. A method of manufacturing a negative electrode for a Li-ion battery, comprising forming the negative electrode from a precursor composition according to any one of embodiments 6-9 or obtainable by a method according to any one of embodiments 26-30, optionally wherein the precursor composition comprises additional components or is combined with additional components during forming, optionally wherein the additional components include binder.
32. A device comprising the electrode according to embodiment 10 or 11, or comprising a Li-ion battery according to embodiment 12 or 13.
33. The device according to embodiment 32, wherein the device is an electric vehicle or a hybrid electric vehicle, or a plug-in hybrid electric vehicle.
34. An energy storage cell comprising a silicon particulate according to any one of embodiments 1-5 or a precursor composition according to any one of embodiments 6-9.
35. An energy storage and conversion system comprising a silicon particulate according to any one of embodiments 1-5 or a precursor composition according to any one of embodiments 6-9.
36. The energy storage and conversion system according to embodiment 35, wherein the system is or comprises a capacitor, or a fuel cell.

Having described the various aspects of the present disclosure in general terms, it will be apparent to those of skill in the art that many modifications and slight variations are possible without departing from the spirit and scope of the present disclosure. The present disclosure is furthermore described by reference to the following, non-limiting working examples.

### EXAMPLES

### Example 1

### Nano-Si Particles Formation

330 g of micronized silicon particles (1-10 μm) were dispersed with 2400 g of water and 600 g of isopropanol and milled in a bead mill machine using 0.35-0.5 mm yttrium-stabilized zirconia at 3.5 kW/l. A fraction of the slurry was collected after 40 min and dried in an air-oven at 110° C. (Nano-Si 1), another fraction was collected after 75 min and dried in a spray drier at 70° C. (Nano-Si 2) and another fraction was collected after 200 min (Nano-Si 3).

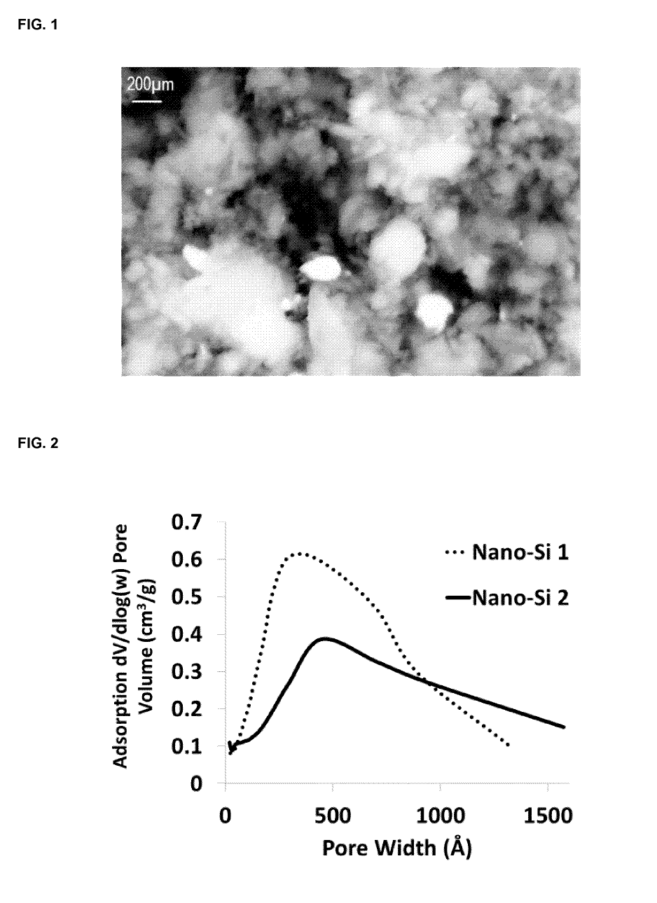

An SEM picture of Nano-Si 1 is shown in FIG. 1. The pore size distributions of Nano-Si 1 and Nano-Si 2 are shown in FIG. 2, with this and additional data summarized in Table 1.

TABLE 1

| | Nano-Si 1 | Nano-Si 2 |
|---|---|---|
| BET (m²/g) | 162.1 | 159.4 |
| Microporosity (%) | 19.5 | 30.2 |
| BJH volume of pores (cm³/g) | 0.564 | 0.392 |
| BJH average pore width (Å) | 165.6 | 145.7 |
| Average Particle Size (Å) | 158.9 | 161.6 |

### Example 2

Dispersion formulation 1: 8.15 g (7%) milled nano-Si 3, 1.0 g ethanol, 14.5 g (85%) graphite active material, 0.34 g (2%) Super C45 conductive carbon black, 34.0 g (6%) CMC (Na-carboxymethylcellulose)/PAA (polyacrylic acid) binder solution (3% solid content in water/ethanol 7:3).

Dispersion preparation: Super C45 conductive carbon black was added to the binder solution, milled nano-Si 3was added and sonicated for 5 min and stirred with a rotor-stator mixer at 11′000 rpm for 5 min. Graphite active material was added with further stirring with rotor-stator mixer at 11′000 rpm for 2 min and stirring with mechanical mixer at 1′000 rpm for 30 min under vacuum.

Dispersion formulation 2: 2.38 g (5%) of a commercial nano-Si (100 nm diameter, US Research Nanomaterials Inc.), 45.12 g (90%) graphite active material, 0.50 g (1%) Super C45 conductive carbon black, 50.0 g (1.5%) CMC (Na-carboxymethylcellulose) binder solution (1.5% solid content in water), 2.6 g (2.5%) SBR (styrene-butadiene rubber) binder solution (50% solid content in water).

Dispersion preparation: Super C45 conductive carbon black and commercial nano-Si were added to the CMC/SBR binder solution and then stirred with a rotor-stator mixer at 11′000 rpm for 5 min. Graphite active material was added with further stirring with rotor-stator mixer at 11′000 rpm for 2 min and stirring with mechanical mixer at 1′000 rpm for 30 min under vacuum. Dispersion formulation 2 is provided for comparative purposes.

Electrochemical capacity and cycling stability for each formulation were tested in accordance with the methods described herein.

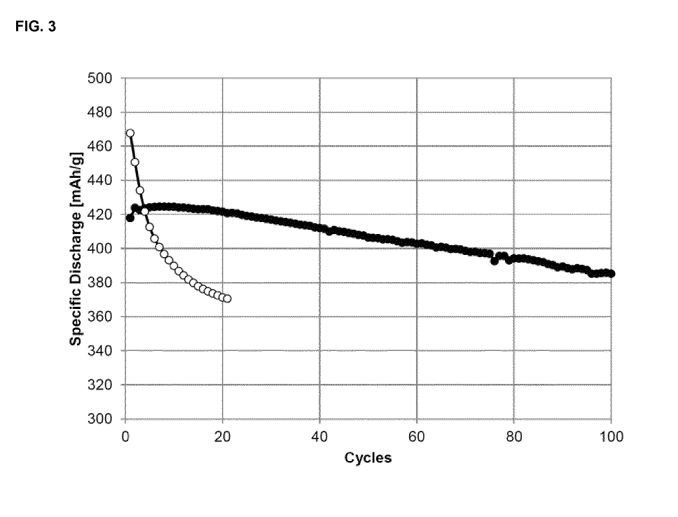

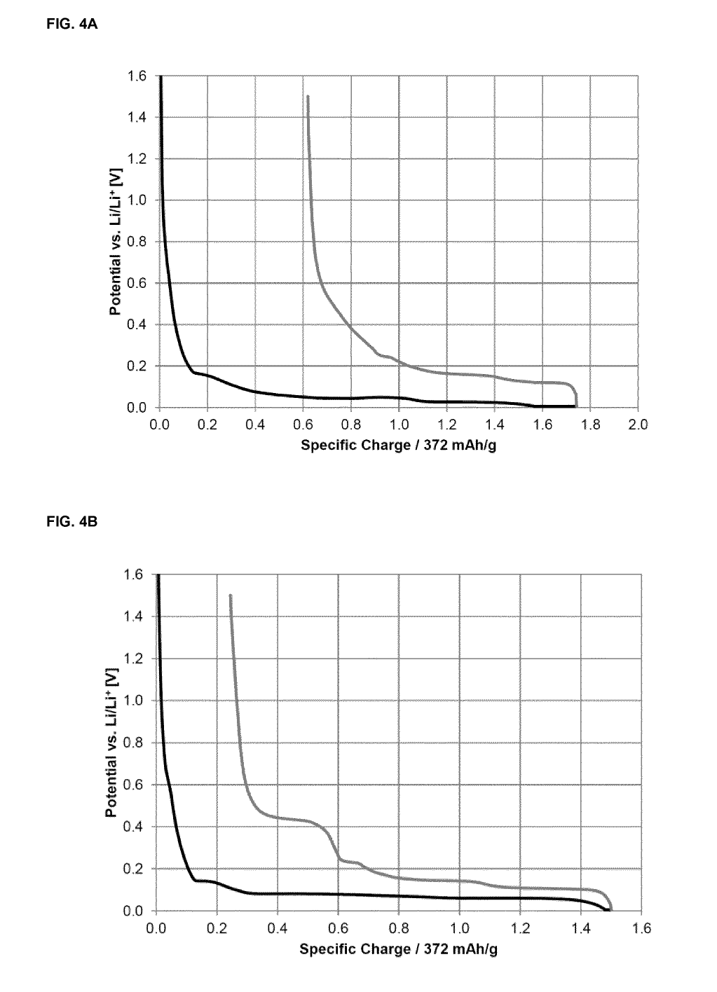

Cycling performance of the negative electrode made from Dispersion formulation 1 containing nano-Si 3 (filled circles) and the negative electrode made from Dispersion formulation 2 containing the commercial nano-Si material (open circles) is shown in FIG. 3. 1^{st} cycle lithium intercalation (black curves) and de-intercalation (gray curves) of the negative electrodes are shown in FIG. 4A (nano-Si 3) and FIG. 4B (commercial nano-Si). The de-intercalation curves (FIGS. 4A and 4B) demonstrate the absence of a plateau at 0.45 V vs. Li/Li⁺ for nano-Si 3, whereas the commercially available nano-Si exhibits such a plateau, indicating significant silicon pulverization.

1. A silicon particulate suitable for use as active material in a negative electrode of a Li-ion battery, having one or more of:
(i) a microporosity of at least 10%,
(ii) a BJH average pore width of from about 110 to 200 Å, and
(iii) a BJH volume of pores of at least about 0.32 cm³/g; wherein:
a. the percentage of the total pore volume that resides in pores having a pore width of from 400 Å to 800 Å is greater than the percentage of the total pore volume that resides in pores having a pore width of greater than 800 Å to 1200 Å, and/or
b. the maximum pore volume contribution is at a pore width of between about 300 and about 500 Å.

2. The silicon particulate according to claim 1, wherein the silicon particulate has a BET SSA of at least about 70 m²/g, and/or an average particle size of less than about 750 Å.

3. A silicon particulate having a nanostructure that
(i) inhibits or prevents silicon pulverization when used as active material in a negative electrode of a Li-ion battery; and/or
(ii) maintains electrochemical capacity of a negative electrode.

4. A precursor composition for a negative electrode of a Li-ion battery, the precursor composition comprising a silicon particulate according to claim 1 and a carbonaceous particulate;
wherein the precursor composition comprises at least two different types of carbonaceous particulate.

5. The precursor composition according to claim 4,
(i) wherein the carbonaceous particulate(s) is selected such that the precursor composition has a microporosity lower than that of the silicon particulate; and/or
(ii) wherein the precursor composition has a microporosity of at least about 5%.

6. An electrode comprising a silicon particulate according to claim 1.

7. A Li-ion battery comprising an electrode according to claim 6, wherein (i) silicon pulverization does not occur during 1^{st} cycle lithium interaction and de-intercalation and/or (ii) electrochemical capacity is maintained after 100 cycles.

8. (canceled)

9. A method comprising charging and discharging a Li-ion battery comprising an electrode according to claim 6, wherein Li is electrochemically extracted from an amorphous lithium silicon phase and in the substantial absence of two crystalline phases containing crystalline silicon metal and crystalline Li₁₅Si₄.alloy.

10. A silicon particulate according to claim 1, wherein the cycling stability of the Li-ion battery is greater than the cycling stability of a Li-ion battery comprising a silicon particulate that is not milled and/or does not have a nanostructure that inhibits or prevents silicon pulverization during during 1^{st} cycle Li intercalation, and/or does not have a nanostructure that maintains electrochemical capacity after 100 cycles,

11. A negative electrode of a Li-ion battery, wherein the electrode comprises a silicon particulate according to claim 1.

12. A method, comprising wet-milling a silicon starting material under conditions to produce a milled silicon particulate have a nanostructure that inhibits or prevents silicon pulverization when used as active material in a negative electrode of a Li-ion battery and/or that maintains electrochemical capacity of a negative electrode;
wherein the silicon starting material is a micronized silicon particulate having a particle size of from about 1 μm to about 100 μm; and
wherein the method comprises one or more of the following:
(i) wet-milling in the presence of a solvent, preferably in an aqueous alcohol-containing mixture,
(ii) wet-milling in a rotor-stator mill, a colloidal mill or a media mill,
(iii) wet-milling under conditions of high shear and/or high power density,
(iv) wet-milling in the presence of relatively hard and dense milling media, and
(v) drying,

13. A method according to claim 12, further comprising combining said silicon particulate with a carbonaceous particulate.

14. A method of manufacturing a negative electrode for a Li-ion battery, comprising forming the negative electrode from a precursor composition according to claim 4 wherein the precursor composition comprises additional components or is combined with additional components during forming, and wherein the additional components include a binder.

15. A device comprising the electrode according to claim 11, wherein the device is an electric vehicle, a hybrid electric vehicle, or a plug-in hybrid electric vehicle.

16. A device comprising the electrode according to claim 11, wherein the device comprises an energy storage cell, an energy storage and conversion system, or a fuel cell.

17. A device comprising the electrode according to claim 11, wherein the device comprises an energy storage and conversion system having a capacitor.

18. A silicon particulate according to claim 1, wherein the silicon particulate is a milled silicon particulate.
